(19) United States
(12) Patent Application Publication
(10) Pub. No.: US 2013/0070209 A1
(43) Pub. Date: Mar. 21, 2013

(54) METHOD AND SYSTEM FOR DYNAMIC FEED-FORWARD POWER CONTROL IN A PROJECTOR SYSTEM

(71) Applicant: Michel Cantelobre, Los Gatos, CA (US)

(72) Inventor: Michel Cantelobre, Los Gatos, CA (US)

(73) Assignee: NATIONAL SEMICONDUCTOR CORPORATION, Santa Clara, CA (US)

(21) Appl. No.: 12/264,115

(22) Filed: Nov. 3, 2008

(51) Int. Cl. G09G 3/02; G03B 21/14

(52) U.S. Cl. 353/37; 345/617

(57) ABSTRACT

A projection system for projecting an output image. The projection system comprises a plurality of laser diodes, each laser diode operable to generate a light beam having a selected intensity in response to a control voltage and a control current and combiner optics for combining light beams received from the plurality of laser diodes to generate an output light beam. A MEMS mirror module receives the output light beam from the combiner optics and generates a scanning light beam that forms the output image on a projection surface. A controller adjusts the control voltage associated with each of the plurality of laser diodes for a first line of pixel data in response to a determination of a level of contrast associated with the first line of pixel data.

### TECHNICAL FIELD

This disclosure is generally related to projector systems and, more specifically, to a method of power control based on the range of contrast in a line of video data.

### BACKGROUND

Solid-state light sources are used in a number of well-known video applications, including video projectors and rear-projection television systems. Common solid-state light sources include semiconductor edge-emitting laser diodes (LDs), vertical cavity surface-emitting laser diodes (VCSELs), diode pumped solid-state frequency doubled (DPSSFD) lasers, and light-emitting diodes (LEDs), among others. Laser-based and LED-based video projectors have been used extensively in business environments and have recently come into wide use in large-screen projection systems in home theaters.

Various laser-based and LED-based projection systems are described in U.S. Pat. No. 7,244,032 (Inamoto), U.S. Pat. No. 7,252,394 (Fu), U.S. Pat. No. 7,255,445 (Kojima), U.S. Pat. No. 7,304,795 (Yavid), and U.S. Pat. No. 7,355,657 (Chilla). The disclosures of U.S. Pat. Nos. 7,244,032, 7,252,394, 7,255,445, 7,304,795, and 7,355,657 are hereby incorporated by reference into the present disclosure as if fully set forth herein.

The miniaturization of projection systems has led to the development of so-called “pico-projectors” that may be embedded in other systems or may be implemented as stand-alone devices. Stand-alone devices include, by way of example, pocket or ultra-mobile projectors that maybe be powered from a battery or an external power source and have a wide range of input options. Embedded applications include, for example, mobile phones and heads-up displays for vehicle dashboards.

An exemplary pico-projector system is the PicoP™ projector engine developed by Microvision, Inc., which has a form factor suitable for implementation in a mobile phone, a vehicle heads-up display (HUD), and other hand-held portable device. The PicoP engine includes RGB laser sources, a micro-electro-mechanical system (MEMS) scanning mirror, optics and video processing electronics for receiving video data from a source and generating an image to be projected on any desired surface (e.g., screen, wall, paper, chair back, etc.). Another exemplary pico-projection system is the Necsel™ projector developed by Novalux, Inc.

However, pico-projection systems face a number of technical problems that are not as critical in larger projection systems, such as table-top projectors, rear-projection televisions, and home theatre projection systems. One of the chief technical problems is power reduction, since many pico-projectors operate mostly or even exclusively on battery power. Advantageously, power reduction also reduces the heat produced by the projector.

Cost reduction is also significant, particularly in embedded systems. For example, the total price of a mobile phone, including the embedded pico-projector, may be effectively limited by consumer demand to a few hundred dollars. Thus, the cost of the pico-projector components must be a fraction of the cost of the projector components of, for example, a rear-projection television.

Therefore, there is a need in the art for pico-projection systems that are ultra-compact, operate at reduced power, and produce less heat. There is also a need for pico-projection systems that cost less and provide enhanced capabilities to a host system, such as a mobile phone.

### BRIEF DESCRIPTION OF THE DRAWINGS

For a more complete understanding of this disclosure and its features, reference is now made to the following description, taken in conjunction with the accompanying drawings, in which:

FIG. 1 is a high-level block diagram of a mobile phone that includes an embedded pico-projection system according to one embodiment of the present disclosure;

FIG. 2 is a block diagram of selected portions of the projector module in FIG. 1 according to one embodiment of the present disclosure;

FIG. 3 illustrates circuitry in the projector module for dynamically adjusting laser diode power according to the principles of the present disclosure;

FIG. 4 is a graph illustrating a line of video data having high contrast;

FIG. 5 is a graph illustrating a line of video data having low contrast; and

FIG. 6 is a flow diagram illustrating the dynamic adjustment of laser diode power according to the principles of the present disclosure.

### DETAILED DESCRIPTION

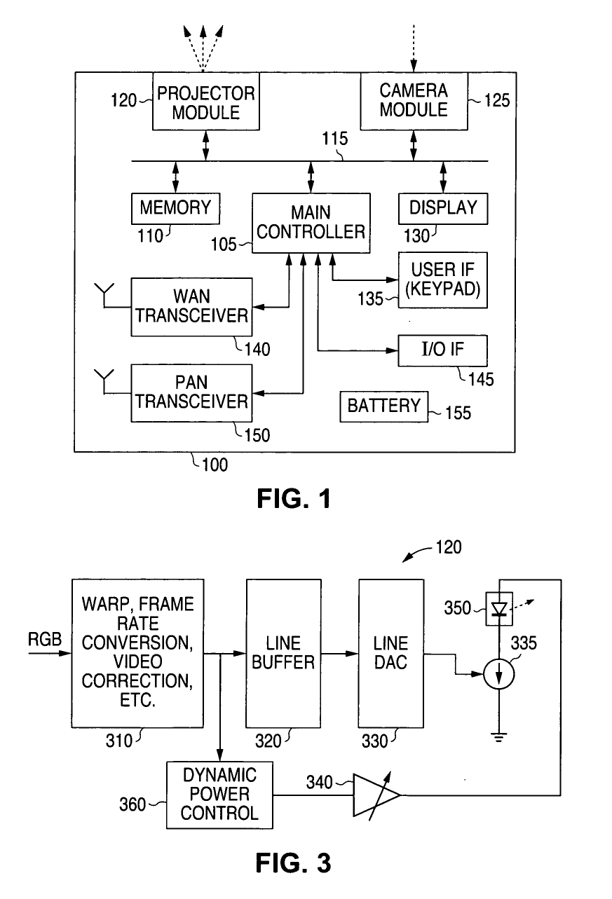

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

FIG. 1 is a high-level block diagram of mobile phone 100, which includes an embedded pico-projection system according to one embodiment of the present disclosure. Mobile phone 100 is merely one illustrative embodiment of the present invention. Those skilled in the art will readily understand that the pico-projection system described herein may be embedded in other types of portable devices or may be implemented as a stand-alone device.

Mobile phone 100 comprises main controller 105, memory block 110, communication bus 115, projector module 120, camera module 125, display block 130, user interface (IF) 135, wide-area network (WAN) transceiver 140, input-output interface (I/O IF) 145, personal-area network (PAN) transceiver 150, and battery 155. With the exception of projector module 120, mobile phone 100 and the components therein are a conventional architecture common to most mobile phones.

Main controller 105 is the central processor that supervises the overall operation of mobile phone 100. Memory block 110 includes one or more conventional read-only memory (ROM) devices, random access memory (RAM) devices (including a Flash RAM), and (optionally) a removable (SD) memory card. Display block 130 comprises typical LCD color display circuitry that is common to most mobile phones. Communication bus 115 enables the transfer of data between main controller 105, memory 110 and display 130, as well as projector module 120 and camera module 123.

User IF 135 may include a conventional keypad and navigation buttons, as well as a touch screen, for receiving input commands and data from the operator of mobile phone 100. I/O IF 145 comprises a communication bus connector, such as, for example, a USB interface that enables main controller 105 to communicate with external devices. I/O IF 145 may also comprise a power supply interface for connecting mobile phone 100 to an external power supply in order to recharge battery 155. Mobile phone 105 operates from the external power supply when connected via I/O IF 145 and operates from battery 155 when disconnected.

WAN transceiver 140 is a long-range transceiver that enables mobile phone 100 to communicate voice and/or data traffic with a wide area network (e.g., a cellular network) via one or more conventional wireless protocols, including, for example, GSM, TDMA, CDMA, WCDMA, WiBro, WIMAX, OFDMA, and the like. PAN transceiver 140 is a very short-range transceiver that enables mobile phone 100 to communicate with a nearby wireless device. PAN transceiver 140 may be, for example, a Bluetooth transceiver that communicates with a wireless headset, a personal computer (PC), or a peripheral device.

Camera module 125 is a conventional embedded camera that is common to many mobile phones. Camera module 125 may comprise, for example, a flash element, a light sensor for sensing ambient light, and camera optics for capturing a still photograph (e.g., a JPEG file) in a first mode or a movie or video file (e.g., AVI or MPEG file) in a second mode. Captured photos or video files may be stored in memory block 110, particularly in an SD card.

Projector module 120 is a pico-projector device (as described hereafter) that uses, for example, three laser diodes (red, green, blue) to project an image onto any suitable surface, such as a wall, a screen, a sheet of paper, a desktop, and the like. Main controller 105 controls projector module 120 in response to user commands that may be received via user IF 135 or external commands that may be received via PAN (Bluetooth) transceiver 150. By way of example, a user may enter commands that cause main controller 105 to retrieve a slide show presentation file from memory 110 and to display the slides via projector module 120 as well as display block 130.

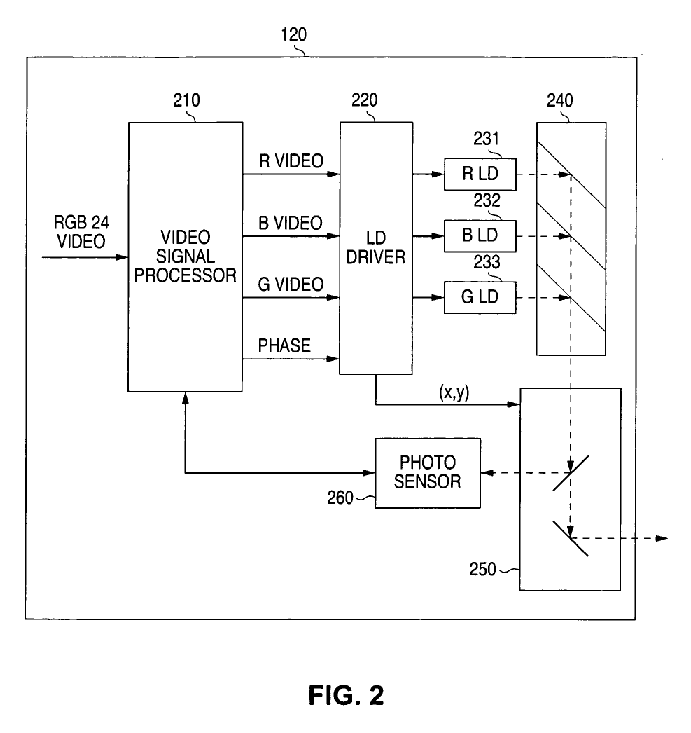

FIG. 2 is a block diagram of selected portions of projector module 120 according to one embodiment of the present disclosure. Projector module 120 comprises video signal processor 210, laser diode driver 220, red laser diode (R LD) 231, blue laser diode (B LD) 232, green laser diode (G LD) 233, combiner optics 240, micro-electromechanical system (MEMS) mirror module 250, and photo sensor 260. The components and operation of projector module 120 are generally well-known. Pico-projectors similar to projector module 120 are commercially available, including, for example, the PicoP projection system made by Microvision, Inc.

Video signal processor (VSP) 210 receives an input stream of RGB 24 video data and performs a number of conventional video processing operations, such as warping, frame rate conversion, video correction, and the like. VSP 210 outputs final video signals, R (red) Video, B (blue) Video, and G (green) Video, and Phase, that control red laser diode 231, blue laser diode 232, and green laser diode 233. LD driver 220 converts the R Video, B Video, G Video, and Phase signals to laser diode control voltages and control currents that control the coherent light generated by laser diodes 231, 232, and 233. The colored laser light beams generated by laser diodes 231, 232, and 233 are combined into a output light beam by combiner optics 240.

LD driver 220 also generates (x,y) control signals that cause MEMS mirror module 250 to generate a scanning pattern that converts the light stream output by combiner optics 240 into a two dimensional (2D) projected image. During a calibration mode, LD driver 220 also generates (x,y) control signals that deflect the output of combiner optics 240 into photo sensor 260, in order to measure the color of the light generated by each one of laser diodes 231, 232, and 233. During the calibration operation, LD driver 220 may turn on only one of laser diodes 231, 232, and 233 at a time in order to measure each read, blue or green light beam individually.

FIG. 3 illustrates circuitry in projector module 120 for dynamically adjusting laser diode power. According to the principles of the present invention, projector module 120 is operable to adjust the control voltages and control currents that control laser diodes 231, 232, and 233 in order to reduce power consumption when scanning a horizontal line of video data (i.e., pixels) that has low contrast for at least a significant portion of the scanned line.

FIG. 3 illustrates a simplified schematic of selected portions of the circuitry in FIG. 2. Processing block 310 comprises the conventional video processing operations (e.g., warping, frame rate conversion, etc.) performed by VSP 210 on a received stream of RGB video data. The final processed lines of video (pixel) data are stored in line buffer 320 prior to projection. Buffer 320 outputs the horizontal lines of pixel data and line digital-to-analog converter (DAC) 330 converts the pixel data from digital data to an analog control current I_{F}. The control current I_{F} controls the light output of laser diode (LD) 350. LD 350 may be any one of laser diodes 231, 232 or 233. As the control current I_{F} increases, the light generated by LD 350 also increases.

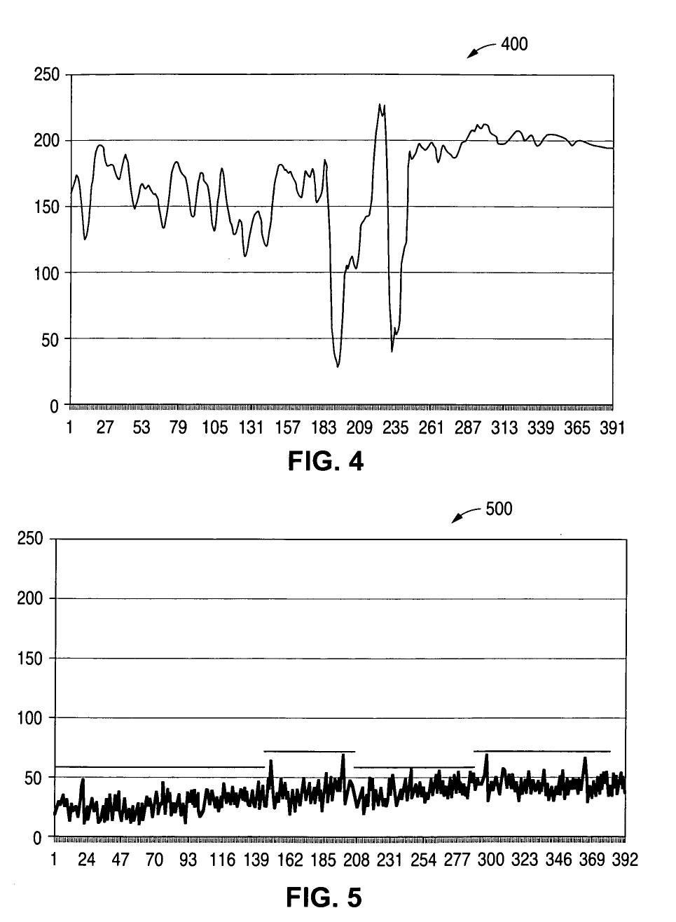

The amount of light generated by LD 350 is also controlled by the forward control voltage V_{F} applied to the anode of LC 350 by amplifier 340. The forward control voltage V_{F} is in turn controlled by dynamic power control (DPC) block 360. DPC block 360 comprises a conventional controller (i.e., processing circuitry, memory, and related logic) that reads the next line of digital pixel data being stored in buffer 320 and determines the next line of pixel data exhibits relatively high contrast or relatively low contrast. FIG. 4 is a graph illustrating a horizontal line of pixel data having relatively high contrast. FIG. 5 is a graph illustrating a horizontal line of pixel data having relatively low contrast.

A line of pixel data having high contrast (as in FIG. 4) will cause a laser diode to sweep through most of its dynamic range between a minimum light output state (i.e., OFF) and a maximum light output state (maximum brightness). In conventional projection systems, the control voltage that controls the laser diode is set to a maximum value that produces the maximum light output, when required, in response to a large input signal current. However, setting the control voltage to the maximum level increases power consumption and is wasteful if the line of pixel data has a relatively low contrast, as in FIG. 5.

Accordingly, the present invention overcomes this problem by setting the laser diode control voltage to a reduced level for lines of pixel data that have relatively low contrast. In a first mode of operation, projector module 120 may reduce the control voltages and control currents that control laser diodes 231, 232, and 233 for the entire scanned line. In a second mode, projector module 120 may reduce the control voltages and control currents that control laser diodes 231, 232, and 233 only during selected segments of the scanned line. In this second mode, different control voltages and control currents are used during different segments of the same line of pixel data. For example, in FIG. 5, four different segments are shown, with different threshold levels of control voltages and control currents represented by solid horizontal lines above the pixel intensity values.

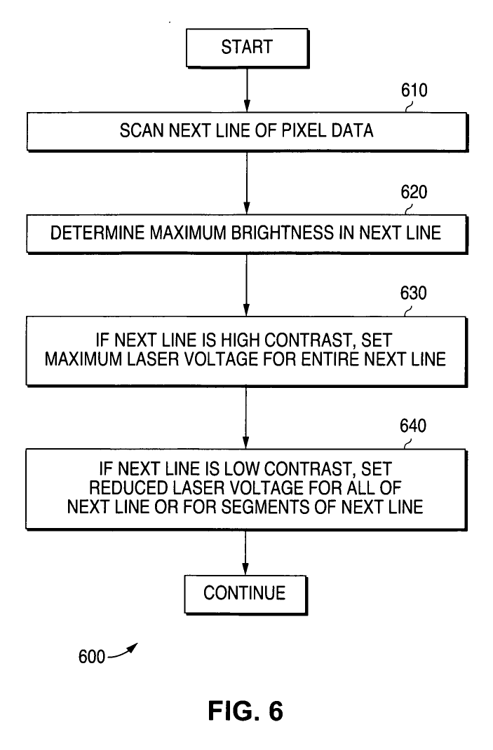

FIG. 6 depicts flow diagram 600, which illustrates the dynamic adjustment of laser diode power according to the principles of the present invention. Initially, dynamic power control block 360 scans the next line of pixel data being stored in line buffer 320 (step 610). Next, dynamic power control block 360 determines the maximum brightness in the next line (step 620). In the next line is a high contrast line, dynamic power control block 360 sets the control voltages for the laser diodes (via amplifier 340) to a maximum level for the entire next line of pixel data (step 630). However, if the next line of pixel data has low contrast, either for the entire line, or for significant portions thereof, dynamic power control block 360 sets the control voltages for the laser diodes to a reduced level for either the entire next line of pixel data, or for at least one segment of the next line of pixel data (step 640).

It may be advantageous to set forth definitions of certain words and phrases used within this patent document. The term “couple” and its derivatives refer to any direct or indirect communication between two or more components, whether or not those components are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The term “each” means every one of at least a subset of the identified items. The phrases “associated with” and “associated therewith,” as well as derivatives thereof, may mean: to include, to be included within, to interconnect with, to contain, to be contained within, to connect to or with, to couple to or with, to be communicable with, to cooperate with, to interleave, to juxtapose, to be proximate to, to be bound to or with, to have, to have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1-21. (canceled)

22. A projection system for projecting an output image, the projection system comprising:
a plurality of laser diodes, each of the laser diodes configured to generate a light beam having a selected intensity in response to a control voltage and a control current, the control voltage for each laser diode representing a forward control voltage for setting a maximum light output for that laser diode, each laser diode associated with a digital-to-analog converter configured to generate the control current for controlling a light output up to the maximum light output for that laser diode based on a digital pixel value in a line of pixel data;
combiner optics configured to combine a plurality of light beams from the laser diodes to generate an output light beam;
a MEMS mirror module configured to receive the output light beam and generate a scanning light beam operable to form the output image on a projection surface; and
a controller configured to generate and adjust the control voltage associated with each of the laser diodes in response to a determination of a level of contrast associated with the line of pixel data;
wherein the controller is configured to adjust the control voltage associated with each of the laser diodes to set a first maximum light output level for a first segment of the line of pixel data in response to a determination that the level of contrast associated with the first segment is relatively high; and
wherein the controller is configured to adjust the control voltage associated with each of the laser diodes to set a reduced second maximum light output level for a second segment of the line of pixel data in response to a determination that the level of contrast associated with the second segment is relatively low.

23. A portable electronic apparatus comprising:
an embedded projection system configured to project an output image, the embedded projection system comprising:
a plurality of laser diodes, each of the laser diodes configured to generate a light beam having a selected intensity in response to a control voltage and a control current, the control voltage for each laser diode representing a forward control voltage for setting a maximum light output for that laser diode, each laser diode associated with a digital-to-analog converter configured to generate the control current for controlling a light output up to the maximum light output for that laser diode based on a digital pixel value in a line of pixel data;
combiner optics configured to combine a plurality of light beams from the laser diodes to generate an output light beam;
a MEMS mirror module configured to receive the output light beam and generate a scanning light beam operable to form the output image on a projection surface; and
a controller configured to generate and adjust the control voltage associated with each of the laser diodes in response to a determination of a level of contrast associated with the line of pixel data;
wherein the controller is configured to adjust the control voltage associated with each of the laser diodes to set a first maximum light output level for a first segment of the line of pixel data in response to a determination that the level of contrast associated with the first segment is relatively high; and
wherein the controller is configured to adjust the control voltage associated with each of the laser diodes to set a reduced second maximum light output level for a second segment of the line of pixel data in response to a determination that the level of contrast associated with the second segment is relatively low

24. The portable electronic apparatus as set forth in claim 23, wherein the portable electronic apparatus comprises a mobile phone.

25. The portable electronic apparatus as set forth in claim 23, wherein the portable electronic apparatus comprises a wireless terminal configured to communicate with a wireless network.

26. For use in a projection system comprising i) a plurality of laser diodes, each laser diode configured to generate a light beam having a selected intensity in response to a control voltage and a control current, the control voltage for each laser diode representing a forward control voltage setting a maximum light output for that laser diode, each laser diode associated with a digital-to-analog converter configured to generate the control current for controlling a light output up to the maximum light output for that laser diode based on a digital pixel value in a line of pixel data; and ii) combiner optics configured to combine light beams from the laser diodes to generate an output light beam, a method of projecting an output image comprising the steps of:
for each laser diode, generating the control current for controlling a light output up to a maximum light output for that laser diode based on digital pixel value in a line of pixel data using a digital-to-analog converter;
determining a level of contrast associated with segments of the line of pixel data; and
for each laser diode, generating and adjusting the control voltage associated with the respective segments of that laser diode using a control block in response to the level of contrast associated with the segments of the line of pixel data, the control voltage representing a forward control voltage for setting a maximum light output for that laser diode;
wherein the step of adjusting comprises:
adjusting the control voltage associated with each of the laser diodes to a first maximum level for a first segment of the line of pixel data in response to a determination that the level of contrast associated with first segment is relatively high; and
adjusting the control voltage associated with each of the laser diodes to a reduced second maximum level for a second segment of the line of pixel data in response to a determination that the level of contrast associated with the second segment is relatively low.
